(19) United States
(12) Patent Application Publication
(10) Pub. No.: US 2017/0276109 A1
(43) Pub. Date: Sep. 28, 2017

(54) INJECTOR HAVING IN-BUILT IGNITION SYSTEM

(71) Applicant: Imagineering, Inc., Kobe-shi, Hyogo (JP)

(72) Inventors: Yuji Ikeda, Hyogo (JP); Minoru Makita, Hyogo (JP)

(73) Assignee: Imagineering, Inc., Kobe-shi, Hyogo (JP)

(21) Appl. No.: 15/314,901

(22) PCT Filed: May 29, 2015
(86) PCT No.: PCT/JP2015/065673

§ 371 Date: May 16, 2017

(30) Foreign Application Priority Data
May 29, 2014 (JP) 2014-111755

(51) Int. Cl. F02M 57/06; F02P 23/04; H01T 13/44; F02P 3/01

(52) U.S. Cl. CPC F02M 57/06; F02P 3/01; F02P 23/04; H01T 13/44

(57) ABSTRACT

A small-size injector having a built-in ignition device which can surely inject fuel and ignite the fuel with low electric power by the ignition device with a simple configuration is provided. The injector comprises a fuel injecting device 2 having a fuel injecting port 20 that injects the fuel, an ignition device 3 configured to ignite the injected fuel, and a casing 10 inside housing therein the fuel injecting device 2 and the ignition device 3 together. The motion device 3 is constituted of a plasma generator 3 which integrally comprises a booster 5 having a resonation structure capacity-coupled with an electromagnetic wave oscillator MW configured to oscillate an electromagnetic wave, and a discharger 6 configured to cause a discharge of a high voltage generated by the booster 5.

### TECHNICAL FIELD

The present invention relates to an injector having a built-in ignition device.

### PRIOR ART

Various injectors incorporated with ignition plug are suggested as injectors incorporating ignition device. These are expected for use to direct-inject-type-engines with regard to diesel engines, gas engines, and gasoline engines. Injectors incorporating ignition device are classified broadly into those having coaxial structure in which the axial center of injector (fuel injecting device) is aligned with the axial center of the central electrode of ignition plug used as ignition device, and those of accommodating fuel injecting device and ignition device within a casing by aligning in parallel. The coaxial structure type is disclosed in, for example, Japanese unexamined patent application publication No. H07-71343, and Japanese unexamined patent application publication No. H07-19142, With regard to the injector incorporating the ignition device, the central electrode of the ignition plug used as the ignition device is constituted into hollow type with step portion formed with sheet member at the tip end, and constituted such that needle for opening and closing the sheet member by the operation of actuator is inserted into the central electrode. Thereby, the attachment to internal combustion engine can easily be performed.

The structure of aligning the fuel injecting device and the ignition device in parallel is disclosed in, for example, Japanese unexamined patent application publication No. 2005-511966 and Japanese unexamined patent application publication No. 2008-255837. The injector incorporating the ignition device is configured to arrange the fuel injecting device and the ignition plug used as the ignition device such that the fuel injecting device and the ignition plug are provided at a predetermined interval in parallel within the cylindrical casing, and formed such that the normal fuel injecting device and ignition plug can be used. Therefore, the fuel injecting device and the ignition plug are not required fur being designed newly.

### PRIOR ART DOCUMENTS

### Patent Document

Patent Document 1: Japanese unexamined patent application publication No. H07-71343

Patent Document 2: Japanese unexamined patent application publication. No. H07-19142

Patent Document 3: Japanese unexamined patent application publication. No. 2005-511966

Patent Document 4: Japanese unexamined patent application publication No 2008-255837

### SUMMARY OF INVENTION

### Problems to Be Solved

However, in the injector incorporating the ignition device disclosed in Japanese unexamined patent application publication No. H07-71343 and Japanese unexamined patent application publication No. H07-19142, there s a problem that the actuator for operating needle of the injection nozzle such as electromagnetic coil and piezo element, may be malfunctioned or damaged caused of influence of high voltage for the ignition plug used as the ignition device. Further, since the injector incorporating the ignition device disclosed in Japanese unexamined patent application publications No. 2005-511966 and No. 2008-255837 is configured to arrange the fuel injecting device and the ignition plug used as the ignition device within one casing and the normal ignition plug is used, there was a problem that the outer diameter length of the ignition plug has limitation for reducing, then the outer diameter of the casing becomes large entirely, and it is difficult to secure space for attaching to the internal combustion engine.

The present invention is developed in view of the above problems. An objective is to provide an injector having a built-in ignition device such that a fuel injecting device and an ignition plug used as the ignition device are arranged within one casing, the ignition device having a small diameter and the fuel injecting device and the ignition device arranged in parallel inside the casing, and even in a configuration in which they are accommodated within one casing, an outer diameter of the device as a whole can be reduced.

### Means to Solve the Problems

An invention for solving the problems is an injector having a built-in ignition device, and the injector comprises a fuel injecting device having an injecting port that injects fuel, an ignition device configured to ignite the injected fuel, and a casing inside housing therein the fuel injecting device and the ignition device together. The ignition device comprises a booster, a ground electrode, and a discharge electrode, the booster having a resonation structure capacity-coupled with an electromagnetic wave oscillator configured to oscillate an electromagnetic wave, all of the booster, the ground electrode, and the discharge electrode being integrally provided to constitute a plasma generator configured to enhance a potential difference between the ground electrode and the discharge electrode by the booster, thereby generating discharge.

The injector having the built-in ignition device of the present invention is configured to arrange the fuel injecting device and the ignition device in parallel and accommodate them within one casing. The accommodated ignition device is constituted of the plasma generator integrally comprising the booster (that has the resonation structure capacity-coupled with the electromagnetic wave oscillator configured to oscillate the electromagnetic wave), the ground electrode, and the discharge electrode. Further, only a discharger can become a high electromagnetic field, an insulating structure in path to the discharger can be simplified, and smaller-sized configuration with smaller diameter can be achieved, compared to generally-used ignition plug. Thereby, the device can be downsized as a whole. Moreover, the booster can he formed by a plurality of resonance circuits, a supplied electromagnetic wave is sufficiently boosted, the potential difference between the ground electrode and the discharge electrode is enhanced (high voltage is generated) in order to cause discharge, and the fuel injected from the fuel injecting device can be ignited. Moreover, the booster (resonator) having the resonation structure can be downsized by increasing frequency of the electromagnetic wave (for example, 2.45 GHz), and this point also contributes to downsize of the plasma generator.

Further, a plurality of the plasma generators can he provided within the casing. By providing a plurality of plasma generators for igniting the fuel as the ignition devices in this manner, the fuel injected from the fuel injecting device can surely be

Further, the plasma generators as the ignition devices can be arranged surrounding the fuel injecting device such that the discharge electrodes of the plasma generators are positioned on a circumference of a circle coaxially with an axial center of the fuel injecting device. By arranging the plasma generators in this manner, the injector having the built-in ignition device including a plurality of the plasma generators can be downsized as a whole. At that time, a plurality of the injecting ports of the fuel injecting device are preferably opened on the circumference of a circle coaxially with the axial center and on an outer surface of the fuel injecting device, and it is preferably adjusted such that each of the discharge electrodes is positioned surrounding the fuel injecting device and further, between the adjacent injecting ports of the fuel injecting device. By adopting such a configuration, fuel does not contact with the discharge electrode directly, the discharger causes the discharge at a mixing region of the fuel with air, and the ignition can suitably be achieved.

### Effect of Invention

An injector having a built-in ignition device in the present invention can reduce an outer diameter of the device as a whole, even in a configuration in which an fuel igniting device and an ignition device are arranged in parallel, and they are accommodated within one casing.

### SIMPLE EXPLANATION OF FIGURES

FIG. 1 illustrates an injector having a built-in ignition device of a first embodiment, (a) is a front view of a partial cross section, and (b) is a plain view of a casing.

FIG. 2 illustrates a fuel injecting device of the injector having the built-in ignition device, (a) is a cross sectional front view showing a fuel cutoff state, and b) is a cross sectional front view showing a fuel injecting state.

FIG. 3 illustrates a plasma generator used as the ignition device of the injector having the built-in ignition device, (a) is a cross sectional front view of a casing divided into two parts, and (b) is a cross sectional front view of a non-divisional casing.

FIG. 4 illustrates different embodiments of a discharge electrode of the plasma generator, and shows au example which partially reduces the size of a discharge gap, specifically, (a) is a teardrop shape seen from the, front, (b) is an elliptical shape, and (c) is a convex-concave shape on a circumference.

FIG. 5 is a front view of a partial cross section illustrating an injector having a built-in ignition device of another embodiment.

FIG.6 illustrates an injector having a built-in ignition device of a modification of the first embodiment, (a) is a front view of a partial cross section, and (b) is a plan view of a casing.

FIG.7 is an equivalent circuit of a booster of the plasma generator.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### First Embodiment

### Injector Having Built-In Ignition Device

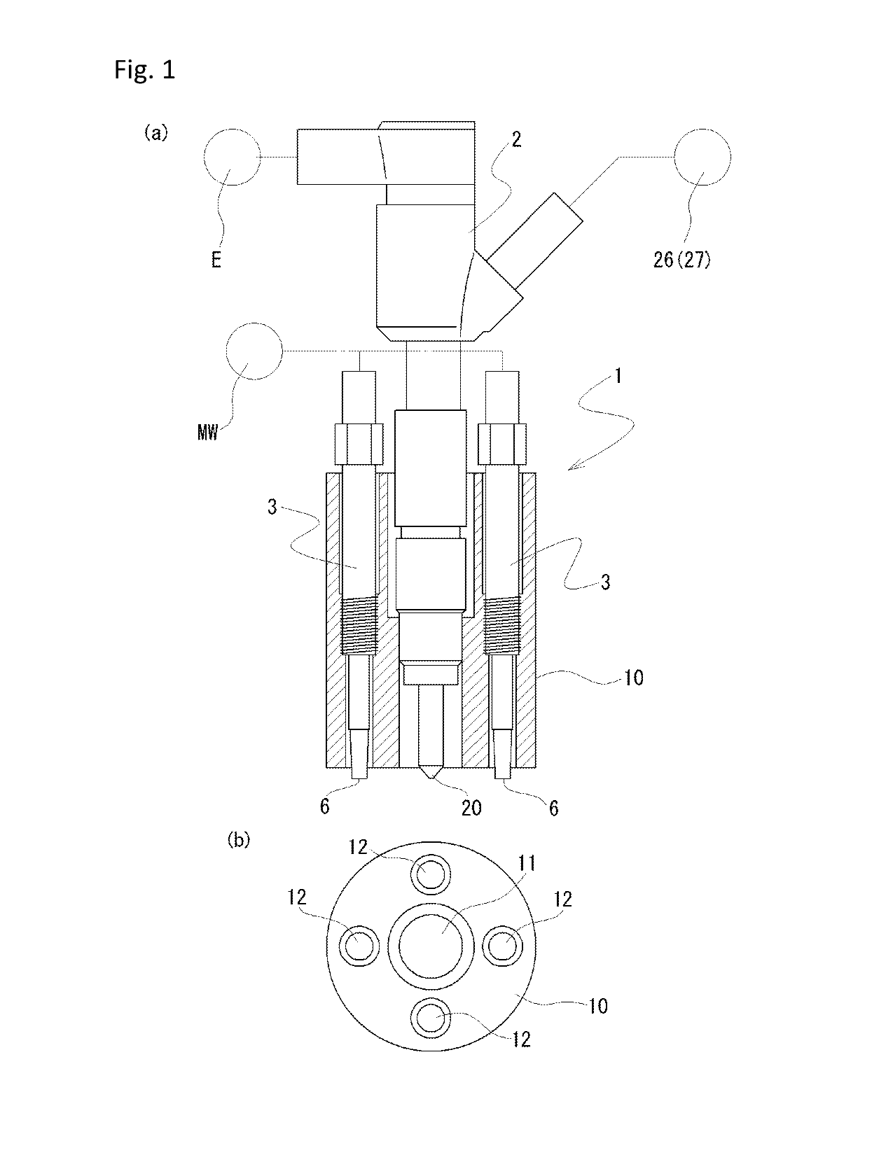

The present first embodiment is an injector 1 having a built-in ignition device regarding the present invention. The injector 1 having the built-in ignition device includes a fuel injecting device 2, a plasma generator 3 used as the ignition device, and a casing 10, as illustrated in FIG. 1.

As illustrated in FIG. 1(b), in the injector 1 having the built-in device, a mounting port 11 for mounting the fuel injecting device 2 in center of the cylindrical casing 10, and a plurality of mounting ports 1 (four locations in the present embodiment) for mounting the plasma generators 3 surrounding the mounting port 11 and concentrically with the axial center of the mounting port 11, are opened on the cylindrical casing 10. Fixing means of the fuel injecting device 2 and the plasma generators 3 towards the mounting ports 11, 12 is t especially limited, sealing member is interposed between them, male screw parts engraved on the outer surfaces of the fuel injecting device 2 and the plasma generators 3 can be engaged into female screw parts engraved on the mounting ports so as to fix, or the fuel injecting device 2 and the plasma generators 3 can be pressured and fixed from upwards by the fixing means.

### Fuel Injecting Device

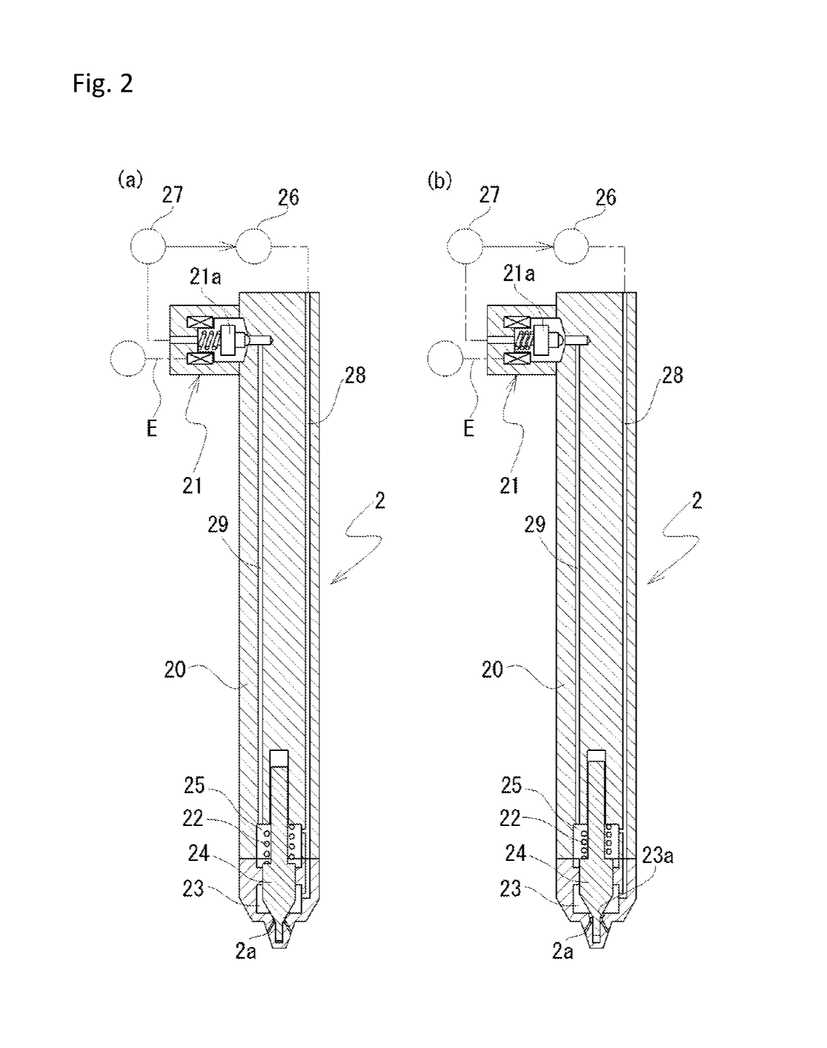

The fuel injecting device 2 is schematically illustrated in FIG. 2. The fuel injecting device 2 is, as already known, configured such that a tip end (valve body) of a nozzle needle 24 is moved toward or away from orifis 23a (valve seat) connected to an injecting port 2a for injecting the fuel by the operation of an actuator 21. As the actuator 21, as illustrated, an electromagnetic coil actuator can be used, but piezo element (piezo element actuator) which can control the fuel injection period and the injection timing (multi-stage injection) in nanoseconds is preferably used as the actuator 21.

Specifically high pressure fuel is introduced from a fuel supply flow path 28 into a pressure chamber 25 and a fuel sump room chamber 23 connected to the orifis 23a fanned in a main body part 20. In a state where the fuel is not injected (referring to FIG. 2(a)), a pressure-receiving surface of a nozzle needle 21 on which the pressure from the high pressure fuel acts is larger in the pressure chamber 25 than the fuel sump room chamber 23, and the nozzle needle 21 is biased to the side of orifis 23a via biasing means 22 (for example, spring). Therefore, the fuel does not flow into an injection port 2a via the orifis 23a from the, fuel sump room chamber 23. The actuator 21 is operated based on injection instructions (for example, current E for driving the fuel injecting valve supplied to the electromagnetic coil actuator) from the control means (for example, ECU), a valve 21a for maintaining airtightness in the pressure chamber 25 is pulled up, the high pressure fuel inside the pressure chamber 25 is released to a tank 27 via an operated flow path 29, the nozzle needle 24 is separated from the orifis 23a by reducing the pressure in the pressure chamber 25 (referring to the FIG. 2(b)). Thereby, the high pressure fuel (gasoline, diesel fuel, gas fuel and etc.) in the fuel sump room chamber 23 passes through the orifis 23a, and is injected from the fuel injection port 2a. The symbol numeral 27 indicates a fuel tank, and the symbol numeral 26 indicates a fuel pump including regulator. The high pressure fuel released out of the injector 1 having the built-in ignition device from the pressure chamber 25 is preferably configured to circulate into the fuel tank 27. However, when the gas is used as the high pressure fuel, it can be configured to be supplied to an intake manifold (suction passage) and mixed with intake air.

Plasma Generator

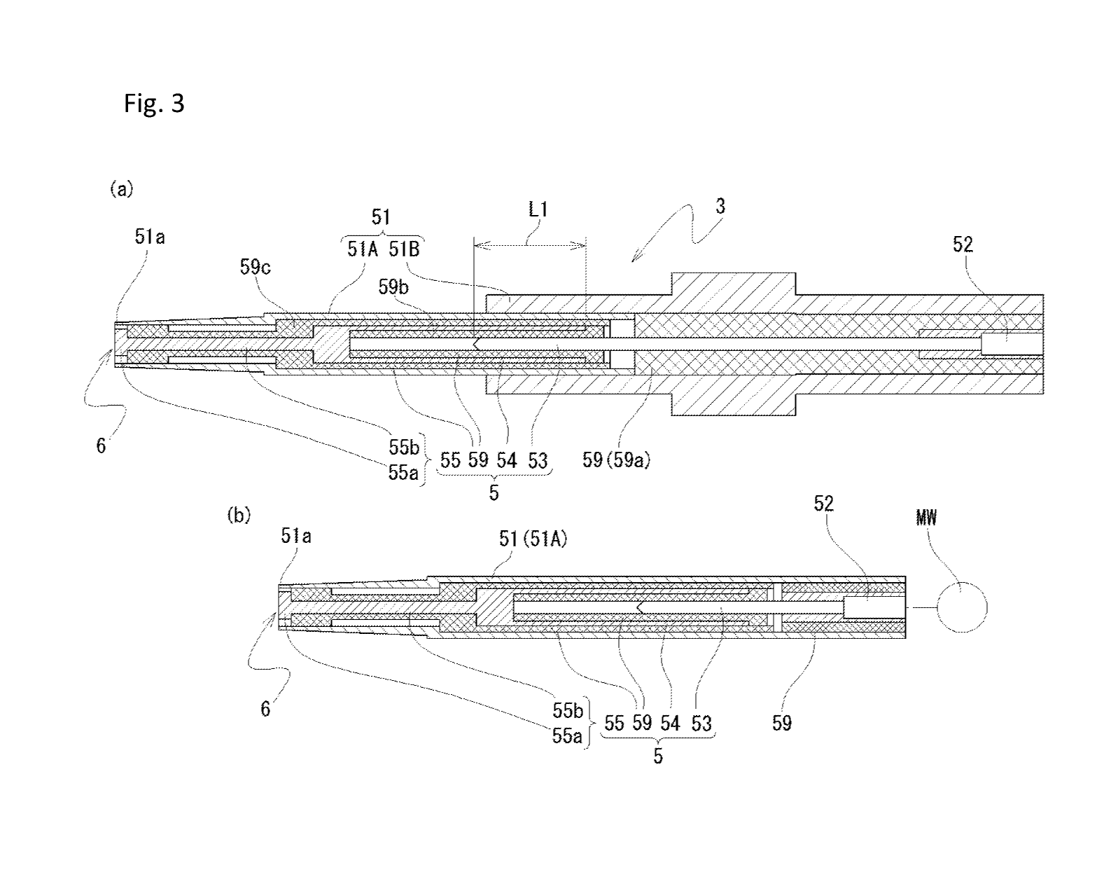

The plasma generator 3 integrally comprises a boosting means 5 (a booster) which has a resonation structure capacity-coupled with an electromagnetic wave oscillator MW for oscillating an electromagnetic wave, a wound electrode (tip end part 51a of the case 51), and a discharge electrode 55a. A potential difference between the wound electrode (tip end part 51a) and the discharge electrode 55a is enhanced by the boosting means 5 (high voltage is generated) in order to generate the discharge. Note that, in FIG. 3, the hatching part in the cross-sectional view indicates metal, and the cross hatching part indicates an insulator.

The boosting means 5 includes a central electrode 53 which is an input part, a Central electrode 55 which is an output part, an electrode 54 which is a combining part, and an insulator 59. The central electrode 53, the central electrode 55, the electrode 54, and the insulator 59 are accommodated coaxially inside the case 51, but not limited to this. The insulator 59 is divided into the following structures, insulator 59a, insulator 59b, and insulator 59c in the present embodiment. The structure is not limited to this. The insulator 59a insulates an input terminal 52 and a part of the central electrode 53 of the input part from the case 51. The insulator 59b insulates the central electrode 53 of the input part from the electrode 54 of the combining part, and both the electrodes are capacity-coupled with. The insulator 59c insulates the electrode 54 of the combining part from the case 51, a shaft part 55b of the central electrode 55 which is an output part is insulated from the case 51 so as to form a resonance space. Further, the insulator 59c has a function of performing positioning of the discharge electrode 55a.

The discharge electrode 55a of the central electrode 55 which is an output part is electrically connected with the electrode 54 of the combining part via the shaft part 55b, The central electrode 53 of the input part is electrically connected to tire electromagnetic wave oscillator MW via the input terminal 52.

The electrode 54 of the combining part has a cylindrical shape with a bottom. A coupling capacity C1 is determined by the inner diameter of the cylindrical part of the electrode 54, the outer diameter of the central electrode 53, and the coupling degree (distance L) between tip end part of the central electrode 53 and the cylindrical part of the electrode 54. In order to adjust the coupling capacity C1 the central electrode 53 cart be arranged movably toward the axial center direction, for example, so as to be adjustable by screw. Furthermore., the adjustment of the coupling capacity C1 cats easily be performed by cutting an opening end part of the electrode 54 obliquely.

The resonance capacity C2 is grounding capacitance (stray capacitance) by capacitor C₂ formed of the electrode 54 of the combining part and the case 51. The resonance capacity C2 is determined by the cylindrical length of the electrode 54 the outer diameter, the inner diameter of the case 51 (the inner diameter of part which covers the electrode 54), space gap between the electrode 54 and the case 51 (space gap of part which covers the electrode 54), and dielectric constant of the insulator 59c. The detailed length of the capacitor C₂ part is designed so as to resonate in accordance with the frequency of the electromagnetic wave (microwave) oscillated from the electromagnetic wave oscillator MW.

The resonance capacity C3 is capacitance at the discharge side (stray capacitance) by capacitor C₃ formed of the part which covers the central electrode 55 of an output part and the central electrode 55 of the case 51. The central electrode 55 of the output part, as described as above, includes the shaft part 55b extended from center of the bottom plate of the electrode 54 of the combining part and the discharge electrode 55a formed at tip end of the shaft part 55b. The discharge electrode 55a has a larger diameter than the shaft part 55b. The resonance capacity C3 is determined by the length of the discharge electrode 55a and the length of the shaft part 55b, the outer diameters, the inner diameter of the case 51 (inner diameter of part which covers the central electrode 55), space gap between the central electrode 55 and the case 51 (space gap of the part in which the tip end part 51a of the case 51 covers the central electrode 55), and the thickness and the dielectric constant of the insulator 59c covering the shaft part 55b. Specifically, area of an annular part formed by the space gap between the outer circumferential surface of the discharge electrode 55a and the inner circumferential surface of the tip end part 51a, and distance between the outer circumferential surface of the discharge electrode 55a and the inner circumferential surface of the end part 51a are important factors for determining the resonance frequency, and therefore, they are more-accurately calculated.

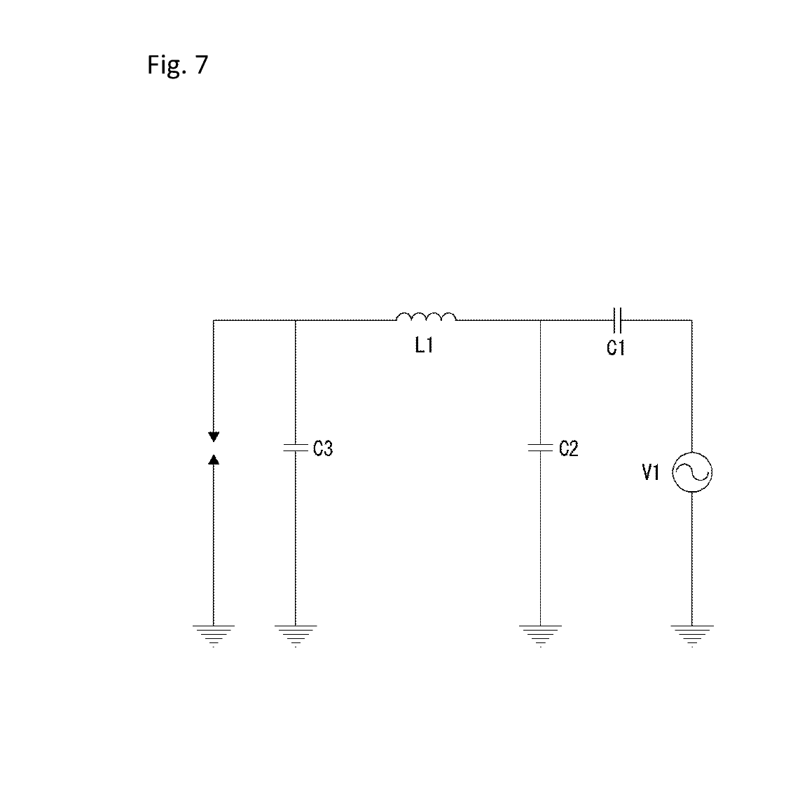

In the resonation structure forming the boosting means 5, with regard to the resonance capacity C2, C3 of capacitor C₂, C₃ (referring to equivalent circuit illustrated in FIG.7) formed between the electrodes (central electrode 53 of the input part and electrode 54 of the combining part) and the casing 51, each length is adjusted such that C2 sufficiently becomes larger than C3 (C2>>C3). By adopting such a configuration the electromagnetic wave is sufficiently boosted to become high voltage, and discharge (breakdown) can be performed.

In the present embodiment, an example in which the case 51 is divided into a tip end case part 51A for accommodating capacitors C₂ and C₃ parts and a rear end case part 51B for connecting the tip end case part 51A with the input terminal 52 so as to accommodate, is illustrated, but not limited to this, and the tip end case part 51A and the rear end case part 51B may be configured integrally. Moreover, in the present embodiment, an example in which the screw part for mounting to the casing 10 is engraved on the rear end case part 51B, and hexagonal surface for engaging tools into is formed, is illustrated, but not limited to this. By adopting a configuration as illustrated in FIG. 3(b), the outer diameter of the plasma generator 3 as the ignition device can be about 5 mm, and the injector 1 having the built-in ignition device can be downsized as a whole.

The discharge electrode 55a is preferably arranged movably in the axial direction toward the shaft part 55b, but the discharge electrode 55a may be formed integrally with the shaft part 55b. Moreover, the resonance capacity C3 can also be adjusted by preparing a plural types of discharge electrodes 55a in which an outer diameter of each discharge electrode differs from each other. Specifically, the male screw part is formed on the tip end of the shaft part 55b, and the female screw part corresponding to the male screw part of the shaft part 55b is formed on the bottom surface of the discharge electrode 55a. Moreover, the shape of the circumferential surface of the discharge electrode 55a may be configured to be wave shape, spherical shape, hemispherical shape, or rotational ellipse body shape, such that the distance between the discharge electrode 55a and the inner surface of the tip end part 51a of the case 51 is different in some points in a direction intersecting with the axial direction. The discharge electrode 55a and the inner surface (ground electrode) of the tip end part 51a of the case 51 constitute a discharger 6, and discharge is generated at the gap between the discharge electrode 55a and the inner surface (ground electrode) of the tip end part 51a of the case 51.

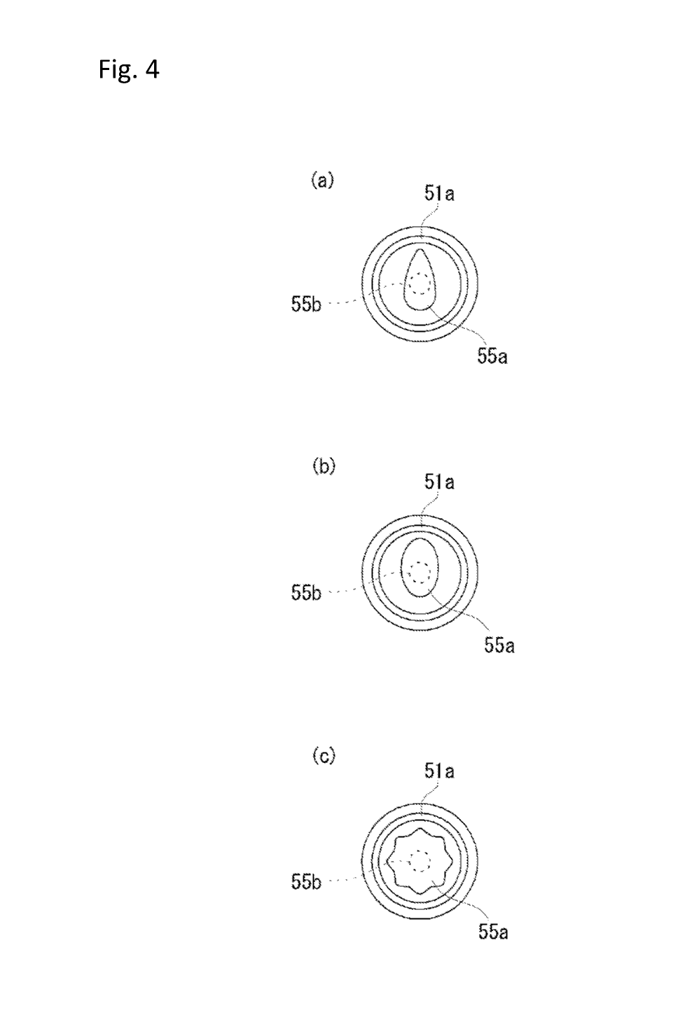

The shape of the discharge electrode 55a forming the discharger 6 may be teardrop shape or elliptic shape as illustrated in FIGS. 4(a) and 4(b) in order to surely perform the discharge, mounted toward the shaft part 55b with eccentricity, or the shape of outer circumference may be a continuous convex-concave shape as illustrated in FIG. 4(c). Thereby, the discharge is surely caused between the inner circumference surface of the tip end part 51a of the case 51 and the sharp head part of the discharge electrode 55a. Note that, even in a case of adopting such a shape, the area of the annular part formed by space gap between the outer circumference surface of the discharge electrode 55a and the inner circumference surface of the tip end part 51a and the distance between the outer circumference surface of the discharge electrode 55a and the inner circumference surface of the tip end part 51a are important factors for determining the resonance frequency, and therefore, the area of the annular part and the distance between the outer circumference surface of the discharge electrode 55a and the inner circumference surface of the tip end part 51a are more-accurately calculated.

By shortening the discharge gap partially in this manner, the discharge can be performed with low power under high atmosphere pressure circumstance. According to experiments by inventors, in a case where the discharge electrode 55a has a cylindrical shape and coaxially with the case 51, the discharge was occurred at 840 W under 8 atm, and was not occurred even at 1 kW under 9 atm. On the other hand, in a case where the discharge gap is partially shortened, it can be confirmed that the discharge is occurred at 500 W under 15 atm. Moreover, if the output is 1.6 kW, it can be confirmed that the discharge occurs under 40 atm or the above.

Operation of Ignition Device

The plasma generating operation of the plasma generator 3 as the ignition device is explained. In the plasma generating operation, the plasma is generated in the vicinity of the discharger 6 caused by the discharge from the discharger 6, and the fuel injected from the fuel injecting valve 2 is ignited.

Specifically, the plasma generating operation is firstly to output an electromagnetic wave oscillation signal with a predetermined frequency f by a control (not illustrated). The signal is synchronized with the fuel infecting signal transmitted to the fuel injecting device 2 (i.e., timing of which a predetermined period has passed after the transmission of the fuel injecting signal), and then the signal is emitted. When the electromagnetic wave oscillator MW receives such an electromagnetic wave oscillation signal, the electromagnetic wave oscillator MW for receiving power supply from an electromagnetic wave source (not illustrated) outputs an electromagnetic wave pulse with the frequency f at a predetermined duty ratio for a predetermined set time. The electromagnetic wave pulse outputted from the electromagnetic wave oscillator MW becomes high voltage by the boosting means 5 of the plasma generator 3 of which the resonance frequency is f. The system of becoming the high voltage, as described as above, can be achieved since it is configured that C2 is sufficiently larger than C3, with regard to the resonance capacitance (stray capacitance) C2, C3, and the stray capacitance C3 between the central electrode 55 and the case 51 and the stray capacitance C2 between the electrode 54 of the combining part and the case 51 are to resonate with a coil (corresponding to the shaft part 55b, specifically, L1 of equivalent circuit). Then, boosted-electromagnetic-wave causes the discharge between the discharge electrode 55a and the inner surface (ground electrode) of the tip end part 51a of the case 51 so as to generate spark. By the spark, the electron is released from gaseous molecule generated in the vicinity of the discharger 6 of the plasma generator 3, the plasma is generated, and the fuel is ignited. Note that, the electromagnetic wave from the electromagnetic wave oscillator MW may be continuous wave (CW).

At that time, a plurality of plasma generators 3 are provided inside the casing 10 such that dischargers 6 are positioned surrounding the fuel injecting device, and further, on a circumference of a circle coaxially with the axial center of the fuel injecting device 2. Thereby, the injector 1 having the built-in ignition device can be downsized as a whole. At that time, a plurality of fuel injecting ports 2a are formed on a circumference of a circle coaxially with the axial center of the fuel injecting device 2 and on outer surface of the fuel injecting device 2, and each discharger 6 is adjusted to he positioned surrounding the fuel injecting device, and further, between adjacent fuel injecting ports of the fuel injecting device. Thereby, fuel never contacts With the dischargers 6 directly; and the dischargers 6 cause the discharge at a mixing region of fuel with air, and the ignition can satisfactorily be achieved.

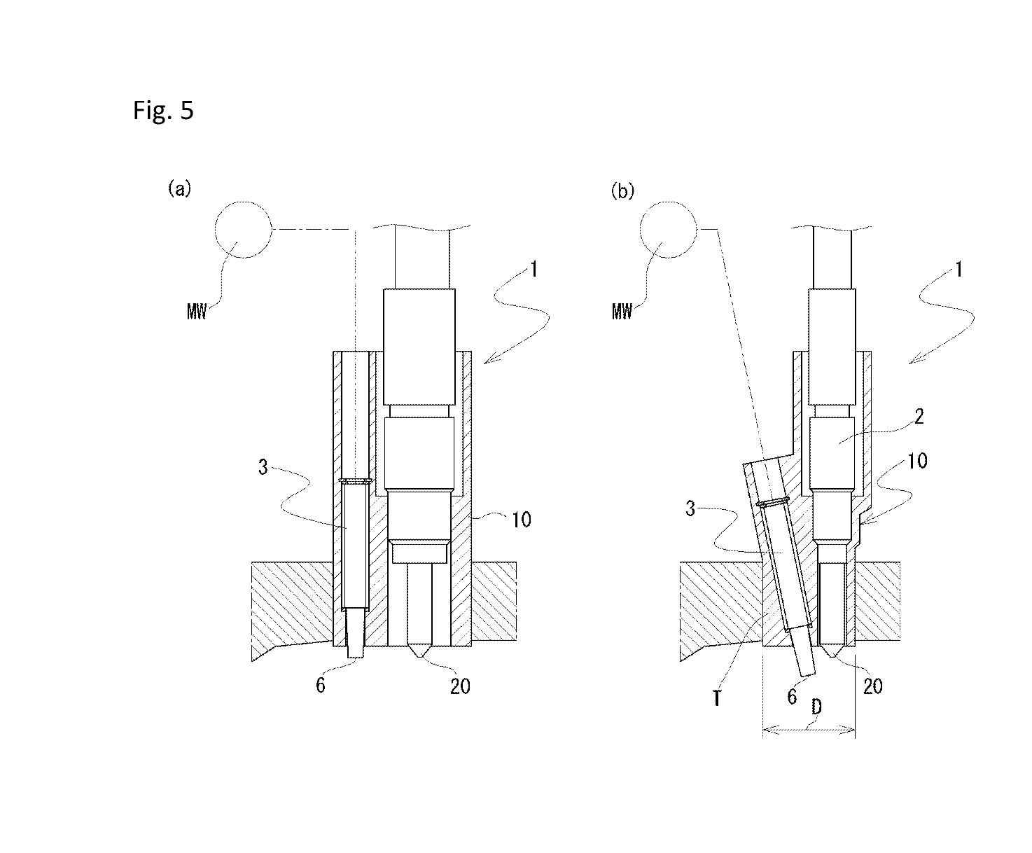

Further, as illustrated in FIG. 5(a), it can be configured such that one fuel injecting device 2 and one plasma generator 3 are arranged in the casing 10. The outer diameter of the casing 10 can significantly be reduced by adopting non-divisional case 51 type as illustrated in FIG. 3(b) for the plasma generator 3.

Moreover, the injector 1 having the built-in ignition device can suitably be used for replacing the fuel of large-size diesel engine truck at a secondhand vehicle market with the gaseous fuel. In this case, as illustrated in FIG. 5(b), by replacing, for example, two-littre diesel injector with 500 cc gas injector (for example, CNG injector), the injector 1 can be mounted as it is for use to an injector-mounted-port opened to an engine in which the outer diameter of the casing 10 is unchanged and original. At that time, by using the plasma generator 3 of non-divisional case 51 type, the plasma generator 3 can be provided with an inclination at a predetermined angle with regard to the axial center of the fuel injecting device 2 (500 cc gas injector). By inclining the plasma generator 3 and disposing it at a predetermined interval from the fuel injecting port 2a, the fuel ignition efficiency is stabilized. Moreover, it is preferably configured such that the plasma generator 3 is mounted movably upwards and downwards (parallel to the axial center of the mounting port 12) within the mounting port 12 of the casing 10, and preferably configured to be secured at a position where the fuel is suitably ignited.

Moreover, by replacing two-littre diesel injector with 500 cc gas injector, the amount and period of fuel injection from a control unit (for example, ECU) are set such that the injection amount becomes quadrupled in total. The setting way is simply to become quadrupled about the injection period, or inject in four divided times at a predetermined time interval.

In an application of replacing the fuel of the large-size diesel engine truck at a secondhand vehicle market with the gaseous fuel as above, the fuel injecting device 2 having outer diameter smaller than that of original fuel injecting device is used, it is combined with the plasma generator 3 of the present invention, and the mounting ports on which the small-sized fuel injecting device 2 and the plasma generator 3 can he provided are formed. By using the casing 10 in which the outer diameter length D of the part T mounted to the cylinder head becomes unchanged and original outer diameter length of the fuel injecting device, fuel can satisfactorily he ignited without performing supplementary work on the cylinder head of the engine, even if the fuel is changed from diesel fuel into gas.

Effect of the First Embodiment

According to the injector 1 having the built-in ignition device of the present first embodiment, the outer diameter length of the plasma generator 3 can be small and then the significant reduction of the outer diameter of the device as a whole can be achieved, even in a configuration in which the fuel injecting device 2 and the plasma generator 3 used as the ignition device are arranged in parallel and accommodated in the casing 10.

First Modification of the First Embodiment

In a first modification of the first embodiment, an electromagnetic wave irradiation antenna 4 is provided, and the antenna is configured to supply an electromagnetic wave into the discharge plasma from the plasma generator 3 as the ignition device, and maintain and expand the plasma. The configuration other than the arrangement of the electromagnetic wave irradiation antenna 4 is similar with the first embodiment, and the explanation is omitted.

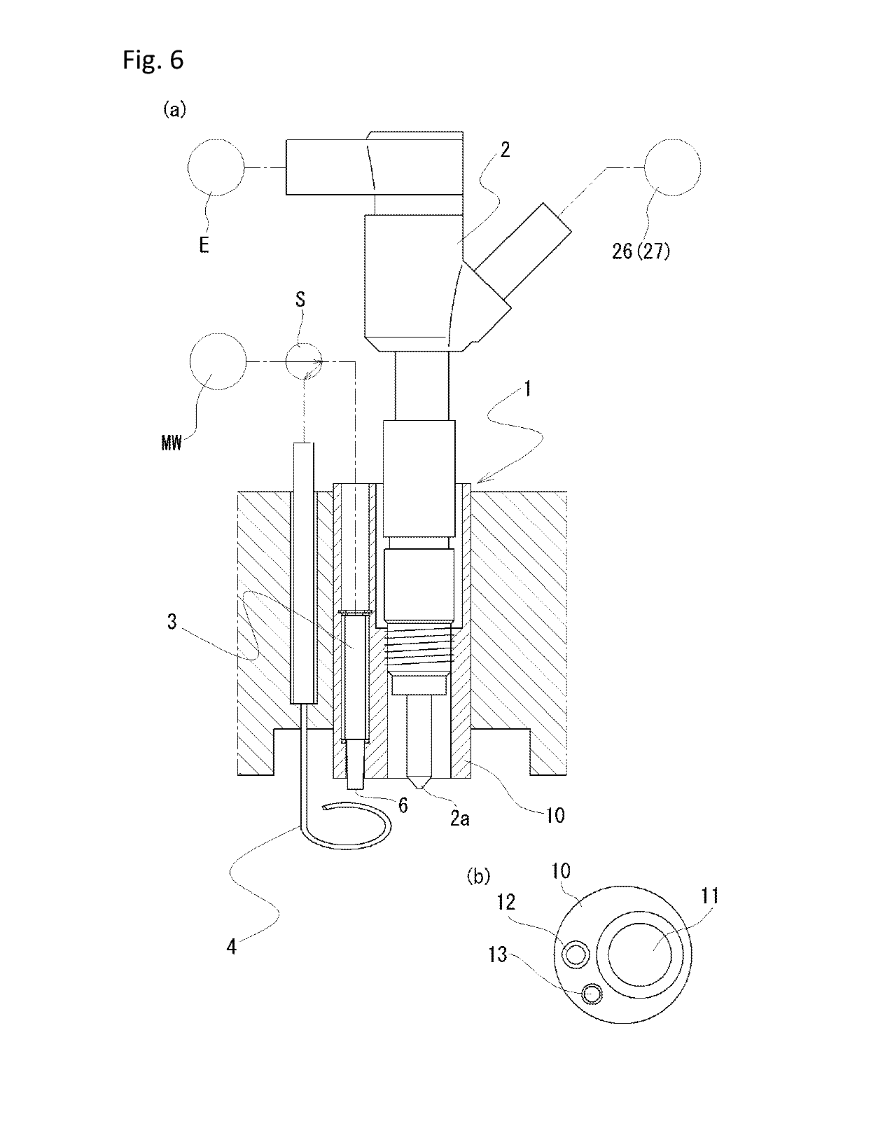

The electromagnetic wave irradiation antenna 4 can be mounted to, for example, the cylinder head of the internal combustion engine by making a mounting port, separately from the casing 10, as illustrated in FIG. 6(a). However, as illustrated in FIG. 6(b), the electromagnetic wave irradiation antenna 4 is preferably mounted to the casing 10 by making the mounting port 13 thereon. In this case, the number of the mounting port 13 for mounting the antenna is not limited to one, and the mounting ports 13 are provided on multiple positions.

The electromagnetic wave supplied into the electromagnetic wave irradiation antenna 4 is supplied with the reflection wave of the electromagnetic wave supplied into the plasma generator 3 via circulator S. The circulator includes three or more input-output-terminals, and it is a circuit in which the input-output-direction of each terminal is determined. In the present embodiment, the wire connection is performed, in which the electromagnetic wave from the electromagnetic wave oscillator MW flows into the plasma generator 3, and the reflection wave from the plasma generator 3 flows into the electromagnetic wave irradiation antenna 4. By using the circulator S and using the reflection wave of the plasma generator 3, there is no need for preparing an additional electromagnetic wave oscillator for the electromagnetic wave irradiation antenna 4.

By irradiating the reflection wave from the plasma generator 3 via circulator S in this manner, plasma generated at a local plasma generation region can be maintained and expanded, and the fuel injected from the fuel injecting device 2 can stably be ignited.

The length of the electromagnetic wave irradiation antenna 4 is preferably set so as to be integer multiple of λ/4 when the frequency of the electromagnetic wave irradiated is λ.

Further, an electromagnetic wave oscillator for the electromagnetic wave irradiation antenna 4 is prepared, and the electromagnetic wave (microwave) from the electromagnetic wave irradiation antenna 4 may be irradiated as continuous wave (CW) or pulse wave.

### INDUSTRIAL APPLICABILITY

As explained as above, the injector having the built-in ignition device of the present invention, uses as the ignition device, the small-sized plasma generator for being able to boost the electromagnetic wave and discharge. Therefore, the outer diameter of the device can entirely be reduced even in a configuration of arranging the fuel injecting device and the ignition device in parallel and accommodating them in one casing. Thus, arranging position of the injector having the built-in ignition device can freely be selected, and the injector having the built-in ignition device can be used for various internal combustion engines. Moreover, the injector having the built-in ignition device can be used for internal combustion engine based on gasoline engine, diesel engine which uses as fuel, natural gas, coal mine gas, shale gas and etc, specifically the injector can be used for engine based on diesel engine which uses gas (CNG gas or LPG gas) as fuel from the viewpoint of the improvement of fuel consumption and environment.

### NUMERAL EXPLANATION

1 Injector Having Built-in Ignition Device

10 Casing

2 Fuel Injecting Device

2a Injecting Port

22 Biasing Means

23 Fuel Sump Room Chamber

24 Nozzle Needle

25 Pressure Chamber

3 Plasma Generator

4 Electromagnetic Wave Irradiation Antenna

5 Boosting Means

51 Case

51a Tip End Part

52 Input Terminal

53 Central Electrode of Input Part

54 Electrode of Combining Part

55 Central Electrode of Output Part

55a Discharge Electrode

59 Insulator

6 Discharger

1. An injector having a built-in ignition device comprising:
a fuel injecting device having an injecting port that injects fuel;
a ignition device configured to ignite the injected fuel; and
a casing inside housing therein the fuel injecting device and the ignition device together, and
wherein the ignition device comprises a booster, a ground electrode, and a discharge electrode, the booster having a resonation structure capacity-coupled with an electromagnetic wave oscillator configured to oscillate an electromagnetic wave, all of the booster, the ground electrode and the discharge electrode being integrally provided to constitute a plasma generator configured to enhance a potential difference between the ground electrode and the discharge electrode by the booster, thereby generating a discharge.

2. The injector according to claim 1,
wherein a plurality of the plasma generators are provided inside the casing.

3. The injector according to claim 2,
wherein the plasma generator has a discharger positioned on a circumference of a circle coaxially with an axial center of the fuel injecting device.
